(19) United States
(12) Patent Application Publication
(10) Pub. No.: US 2026/0074555 A1
(43) Pub. Date: Mar. 12, 2026

(54) DYNAMIC POWER MANAGEMENT BASED ON MEASUREMENTS OF USB POWER FROM AIRCRAFT POWER SYSTEM TO PASSENGER ELECTRONIC DEVICES

(71) Applicant: Thales Avionics, Inc., Irvine, CA (US)

(72) Inventors: Jueren MA, Placentia, CA (US); Bipin BOPALIYA, Irvine, CA (US); Fariborz SHAFAI, Irvine, CA (US); Ton DO, Corona, CA (US); Chet THAKAR, Foothill Ranch, CA (US)

(21) Appl. No.: 18/829,937

(22) Filed: Sep. 10, 2024

(51) Int. Cl. H02J 13/00

(52) U.S. Cl. CPC H02J 13/12

(57) ABSTRACT

A power management system includes power monitor circuits and a power manager circuit. The power monitor circuits each measure actual power supplied to one of the user electronic devices (UEDs). The power manager circuit negotiates with the UEDs agreement for subscription power levels that the UEDs are authorized to be supplied. The power manager circuit allows an oversubscription state by operations agreeing to subscription power levels for the UEDs that when combined exceeds a maximum power supply capability of the power management system. The power manager circuit, for each UED, determines a present actual power usage of the UED based on the measurements, determines a present total actual power usage of the UEDs, and responds to the present total actual power usage exceeding the maximum power supply capability minus a first threshold offset, by renegotiating an agreement with at least one of the UEDs for a lower subscription power level.

### FIELD

The present disclosure relates to power management for passenger devices using aircraft power systems.

### BACKGROUND

There is an ever-increasing demand from passengers on commercial passenger aircrafts to power (charge) their portable personal electronic devices (“PEDs”), such as, for example, smart phones, tablet computers, laptop computers, virtual reality headsets, portable game consoles, etc. In addition, many commercial passenger aircrafts provide wireless Internet connection to such PEDs, which even more so increases the consumer demand to use PEDs on a flight to access the Internet for personal, as well as work purposes. This need can be challenging to satisfy in view of aircraft having a limited power supply from engine-driven generator(s).

There is a need in aircraft for a power management system that prevents an over-demand condition on the aircraft's electrical system, while also being able to supply power to a variable number and type of passenger PEDs that may connect to the system during a flight.

Existing systems in the industry that manage the power available to passenger PEDs can deny power to a newly connected PED in some manner, such as, for example, when other connected PEDs have already been allocated power such that insufficient remaining power is available for the newly connected PED. The primary reason why existing systems deny power to some or all passenger PEDs is that such loads on the aircraft's electrical system by, in some cases, a large number of passengers (e.g., hundreds of passengers) simultaneously demanding power for their PEDs could overwhelm the aircraft's electrical system, resulting in an unsafe condition. For example, modern PEDs, including laptops, smart devices, and tablets, can draw anywhere from 2.5 W to 100 W. Such power consumption multiplied by hundreds of passengers could overwhelm the aircraft's electrical system in an unsafe manner. At the same time, denial of power to passenger PEDs, while not necessarily unsafe, is still an undesirable outcome and will likely reduce passenger satisfaction.

Universal Serial Bus (USB) is an increasingly pervasive industry standard that defines cables, connectors, and communication protocols used in a bus for connection, data communications, and power supply between computers and electrical devices, such as portable personal electronic devices. USB has become commonplace on laptop computers, smart phones, and tablet computers.

A passenger seat may include a USB Type C charging outlet that enables a PED to be powered by the aircraft electrical power through a USB Type C (USB-C) cable or through a wireless charging device (e.g., Qi standard). USB Type C builds on the USB 4 protocol published by the USB Implementers Forum (http://www.usb.org/home). USB Type C is also backwards compatible with older USB protocols.

Furthermore, a USB Power Delivery (USB PD) specification enables the delivery of higher power levels. The specifications for this technology can be found at http://www.usb.org/developers/powerdelivery/. The USB PD technology was developed to create a universal power plug for laptops, tablets, smart phones, etc. that may require more than 5 volts (V) using cables and plugs compatible with existing USB solutions. The USB PD specification defines a communication link between USB ports, e.g., connected via a cable supporting USB PD and connectors supporting USB PD. The USB PD specification permits power consumption of, e.g., up to 100 W, to support high power consuming portable devices, such as laptop computers. Unfortunately, existing power management systems for commercial passenger aircrafts have not been designed to support such high-power consuming devices within their fixed power supply environment.

Therefore, a need exists to overcome the problems with the prior art as discussed above.

### SUMMARY

Various embodiments of the present disclosure are directed to overcoming a limitation of prior power management systems where the total subscription power level that could be agreed to be supplied to user electronic devices (UEDs) was limited to not exceed the maximum power supply capability of the power management system. This limitation was strictly followed despite that the UEDs requested power levels that can be based on their respective highest-rated power scenarios. A UED's highest-rated power scenario may correspond to the total power that the UED is rated to draw while its battery is charging from a very low state-of-charge, its processor(s) are running at a highest rated speed, its mass storage device(s) is drawing highest rated power, its communication transceivers are drawing highest rated power, its display is set at a highest brightness and refresh rate, etc. Because the UEDs may usually or nearly-always actually draw much lower power levels than their highest-rated power prior power management systems, this resulted in the power management system having power capacity that is reserved (subscribed) for use by some UEDs and therefore not available for use by other UEDs.

In accordance with some embodiments of the present disclosure, a power management system is provided that can allow an oversubscription state to occur by agreeing to subscription power levels for user electronic devices (UEDs) that when combined into a total subscription power level exceeds a maximum power supply capability of the power management system. To avoid the oversubscription state from allowing a scenario where the UEDs attempt at some time instant to draw a total power level that exceeds the maximum power supply capability, the power management system can monitor in real-time or near-real-time the present actual power usage of individual ones of the UEDs. The power management system can then immediately respond to a determination that the present total actual power usage across all of the UEDs exceeds the maximum power supply capability of the power management system minus a first threshold offset, by performing renegotiation of an agreement with at least one of the UEDs for a lower subscription power level relative to what was earlier agreed.

In one embodiment, a power management system is provided that includes power monitor and control circuits and a power manager circuit. The power monitor and control circuits are connected to power outputs configured to supply power to UEDs. Each of the power monitor and control circuits are configured to measure actual power supplied through one of the power outputs to one of the connected UEDs and to responsively generate a measured power indication. The power manager circuit is configured to perform operations to, for each of the UEDs, negotiate with the UED an agreement for a subscription power level that the UED is authorized to be supplied by the power management system. The power manager circuit is configured to allow an oversubscription state by operations agreeing to subscription power levels for the UEDs that when combined into a total subscription power level exceeds a maximum power supply capability of the power management system.

The power monitor circuit controls power level supplied to the connected UED based on the subscription power level for the UED and/or based on a command from the power manager circuit. The power manager circuit performs operations to, for each of the UEDs, determine a present actual power usage of the UED based on the measured power indication from the power monitor circuit measuring actual power supplied through the power output connected to the UED. The power manager circuit performs operations to determine a present total actual power usage of the UEDs based on a combination of the measured power indications from the power monitor and control circuits. The power manager circuit responds to determining that the present total actual power usage of the UEDs exceeds the maximum power supply capability of the power management system minus a first threshold offset, by renegotiating an agreement with at least one of the UEDs for a lower subscription power level that the at least one of the UEDs is authorized to be supplied so that the total actual power usage of the UEDs will cease exceeding the maximum power supply capability of the power management system minus the first threshold offset.

Other power management systems and corresponding methods and computer program products according to embodiments of the present disclosure will be or become apparent to one with skill in the art upon review of the following drawings and detailed description. Moreover, it is intended that all embodiments disclosed herein can be implemented separately or combined in any way and/or combination.

### BRIEF DESCRIPTION OF THE DRAWINGS

The accompanying drawings, which are included to provide a further understanding of the disclosure and are incorporated in a constitute a part of this application, illustrate certain non-limiting embodiments of inventive concepts. In the drawings:

FIG. 1 illustrates a component block diagram of an aircraft communication system, satellites, and ground communication system which are configured to operate in accordance with various embodiments of the present disclosure;

FIG. 2 illustrates a power management system that includes power monitor and control circuits and a power manager circuit which are configured to operate in accordance with various embodiments of the present disclosure;

FIG. 3 illustrates a flowchart of optional operations by the power manager circuit to negotiate subscription power levels with the UEDs while allowing oversubscription of the combined total subscription power levels for the UEDs, and to renegotiate an agreement with at least one of the UEDs for a lower subscription power level when the total actual power usage of the UEDs exceeds the maximum power supply capability of the power management system minus a first threshold offset, in accordance with various embodiments of the present disclosure;

FIG. 4 illustrates a flowchart of optional operations by the power manager circuit to negotiate subscription power levels with the UEDs while allowing oversubscription of the combined total subscription power levels for the UEDs, in accordance with various embodiments of the present disclosure;

FIGS. 5 and 6 illustrate flowcharts of optional operations by the power manager circuit to select a UED for renegotiation of lower subscription power level or to prioritize which UEDs are prioritized for renegotiation of lower subscription power levels, in accordance with various embodiments of the present disclosure;

FIG. 7 illustrates a flowchart of optional operations by the power manager circuit, when performing the operations to negotiate with UEDs agreement for a subscription power level that the UEDs are authorized to be supplied, to consider how quickly the UED can be charged to at least one threshold state-of-charge level and/or to consider how long the UED can remain operational based on the UED's present state-of-charge level and/or based on charging the UED to a future state-of-charge level, in accordance with various embodiments of the present disclosure;

FIG. 8 illustrates a flowchart of optional operations by the power manager circuit to respond to a determination that the present total actual power usage of the UEDs exceeds the maximum power supply capability of the power management system minus the first threshold offset by prioritizing which of the UEDs to renegotiate with based on considering one or more of: how quickly the UEDs can be charged to at least one threshold state-of-charge level; and/or how long a UED can remain operational based on the UED's present state-of-charge level and/or based on charging the UED to a future state-of-charge level, in accordance with various embodiments of the present disclosure; and FIG. 9 illustrates a flowchart of optional operations by the power manager circuit to respond to a determination that the present total actual power usage of the UEDs exceeds the maximum power supply capability of the power management system minus the first threshold offset by determining what lower subscription power level will be authorized to which of the UEDs based on considering one or more of: how quickly the UEDs can be charged to at least one threshold state-of-charge level; and/or how long a UED can remain operational based on the UED's present state-of-charge level and/or based on charging the UED to a future state-of-charge level, in accordance with various embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of various present inventive concepts to those skilled in the art. It should also be noted that these embodiments are not mutually exclusive. Components from one embodiment may be tacitly assumed to be present or used in another embodiment.

As explained above, existing power management systems for commercial passenger aircrafts have not been designed to support high-power consuming devices used by numerous passengers during flights and, therefore, presents a multifaceted challenge tied to various constraints and uncertainties inherent in the systems.

As explained above, a limitation of prior power management systems is that the total subscription power level that could be agreed to be supplied to UEDs was limited to not exceed the maximum power supply capability of the power management system. This limitation was strictly followed despite that the UEDs requesting power levels that can be based on their respective highest-rated power scenarios. A UED's highest-rated power scenario may correspond to the total power that the UED is rated to draw while its battery is charging from a very low state-of-charge, its processor(s) are running at a highest rated speed, its mass storage device(s) is drawing highest rated power, its communication transceivers are drawing highest rated power, its display is set at a highest brightness and refresh rate, etc. Because the UEDs may usually or nearly-always actually draw much lower power levels than their highest-rated power prior power management systems, this resulted in the power management system having power capacity that is reserved for use by some UEDs and therefore not available for use by other UEDs.

In accordance with some embodiments of the present disclosure, a power management system is provided that can allow an oversubscription state to occur by agreeing to subscription power levels for UEDs that when combined into a total subscription power level exceeds a maximum power supply capability of the power management system. To avoid the oversubscription state from allowing a scenario where the UEDs attempt at some time instant to draw a total power level that exceeds the maximum power supply capability, the power management system can monitor in real-time or near-real-time the present actual power usage of individual ones of the UEDs and respond to determining that the present total actual power usage across all of the UEDs exceeds the maximum power supply capability of the power management system minus a first threshold offset, by performing renegotiation of an agreement with at least one of the UEDs for a lower subscription power level.

Before discussing the example operations of the power management system, an overview is provided of example components of aircraft and ground communication systems.

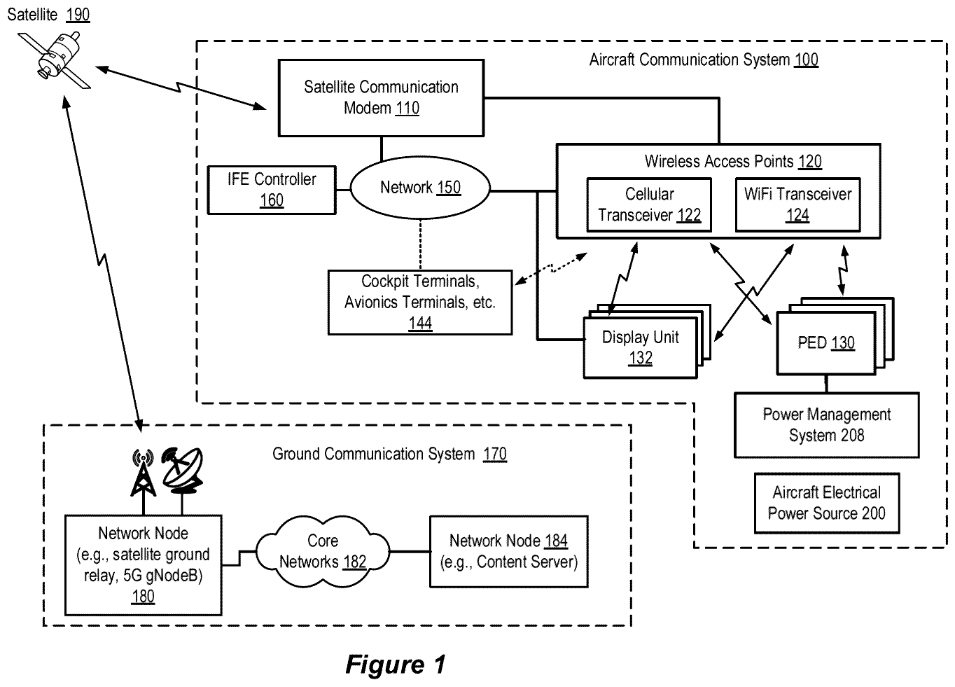

FIG. 1 illustrates a component block diagram of an aircraft communication system 100, satellite 190, and ground communication system 170 which are configured to operate in accordance with various embodiments of the present disclosure.

Referring to FIG. 1, the aircraft communication system 100 communicates with the ground communication system 170 using various communication technologies, e.g., proprietary satellite protocols, 3GPP 5G protocols, etc. More particularly, the aircraft communication system 100 includes a satellite communication modem 110 that transmits and receives signaling through one or more satellite antennas which is relayed by satellite(s) 190 to and from a radio communication network node 180 (e.g., satellite gateway, 5G gNodeB, etc.).

On the aircraft, signals received by the satellite communication modem 110 through satellite aperture antenna(s) are transported via RF link or Common Public Radio Interface (CPRI) interface (e.g., Ethernet or fiber optic links) and one or more networks 150 to wireless access points 120. The wireless access points 120 can include WiFi transceivers 124 (e.g., IEEE 802.11) or cellular transceivers 122 which may be configured to operate to retransmit data towards served terminals (e.g., passenger electronic devices (PEDs) 130, seat video display units 132 (e.g., In-Flight Entertainment (IFE) seat display units), cockpit terminals 144, crew terminals 144, avionics terminals 144, etc.). Similarly, the transceivers /124 can operate in a transport mode to receive and retransmit signals from the served terminals to the satellite communication modem 110 for transmission toward the satellite(s) 190 and relay to the network node 180.

An IFE controller 160 can communicate with ground-based network nodes 184, e.g., content servers (e.g., movies, TV programming, games, e-books, Internet content servers, etc.), through core networks 182 (e.g., private networks and/or public networks such as the Internet) and the network node 180, etc. The IFE controller 160 can operate as an on-board content server for locally stored content to the served terminals.

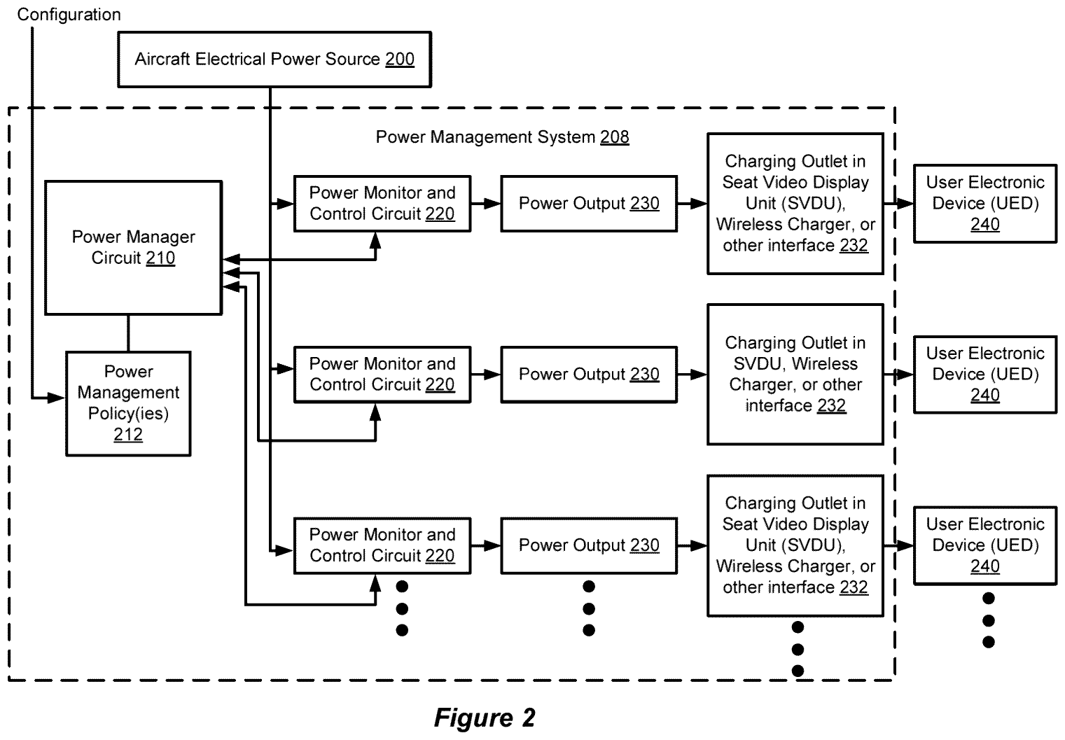

An aircraft electrical power source 200, typically from engine-driven generator(s), supplies power to components of the aircraft communication system 100. Moreover, as explained above, PEDs can be supplied power by the aircraft electrical power source 200 through, e.g., USB wired connections and/or wireless charging (e.g., Qi standard wireless power transfer). A power management system 208 is configured to monitor in real-time or near-real-time the total actual power usage of the PEDs and to respond to determining the present total actual power usage of the PEDs exceeds the maximum power supply capability of the power management system minus a first threshold offset, by renegotiating an agreement with at least one of the PEDs for a lower subscription power level that the at least one of the PEDs is authorized to be supplied so that the total actual power usage of the PEDs will cease exceeding the maximum power supply capability of the power management system minus the first threshold offset. These and other operations of the power management system 208 are discussed below with regard to FIGS. 2-8.

Although embodiments herein are primarily described in the context of in-flight entertainment solutions for an aircraft, the invention is not limited thereto. Instead, these and other related embodiments may be used with other types of vehicles, including without limitation, ships (e.g., cruise ships), trains, subways, and buses. Moreover, these and other related embodiments may be used in non-vehicle applications, such as sports venues, hotels, conference centers, etc. Accordingly, although various embodiments are described in the example context of involving passengers and crew, these and other embodiments can more generally be used by any persons (“users”). Thus the term passenger electronic device (PED) can more broadly be referred to as a user electronic device (UED). The term PED is used herein for purpose of non-limiting explanation of various embodiments and can be replaced with the broader term UED.

FIG. 2 illustrates a power management system 208 that includes power monitor and control circuits 220 and a power manager circuit 210 which are configured to operate in accordance with various embodiments of the present disclosure.

Referring to FIG. 2, the power monitor and control circuits 220 are connected to power outputs 230 and, therethrough, to charging outlets 232 which may correspond to, e.g., USB-C standard connectors in seat video display units, in armrests, etc., and wireless charging interfaces (e.g., Qi standard charging interfaces), and/or other power supply interfaces which are operable to supply power for powering, e.g., charging, connected (e.g., via wired or wireless) UEDs 240.

Although FIG. 2 illustrates three sets of power monitor and control circuits, power outputs, charging outlets, and UEDs, a power management system for a commercial aircraft may have hundreds of such sets to enable passengers to charge one or more UEDs at any of the cabin seats. Moreover, a single power manager circuit 210 may manage power supplied through any plural number of power outputs 230. Thus, for example, one power manager circuit 210 may manage power supplied through all power outputs 230 in a cabin. Alternatively, a plurality of power manager circuits 210 may be provided with each managing the power supplied a plurality of power outputs 230 for use by a passenger at a single seat, at a group of seats along a row, or at another correspondence of power outputs 230 to passenger seats, etc.

Although the power manager circuit 210 is illustrated as being separate from the power monitor and control circuits 220, at least some of the operational functionality described herein may be incorporated into the power monitor and control circuits 220. Accordingly, the power manager circuit 210 may be at least partially incorporated within the power monitor and control circuits 220.

The power monitor and control circuits 220 are configured to supply power from the aircraft electrical power source 200 to UEDs 240. Each of the power monitor and control circuits 220 is configured to measure actual power supplied through one of the power outputs 230 to one of the connected UEDs 240 and to responsively generate a measured power indication. Although the number of power monitor and control circuits 220 is illustrated in FIG. 2 as being equal to the number of charging outlets 232, one or more of the power monitor and control circuits 220 may be configured to measure actual power supplied through more than one of the charging outlets 232, e.g., as a measurement of combined power supplied or as a sequential measurement performed through sequential temporary connections (e.g., through a multiplexer or other switched circuit) to measure one at a time the power supplied through a plurality of the charging outlets 232.

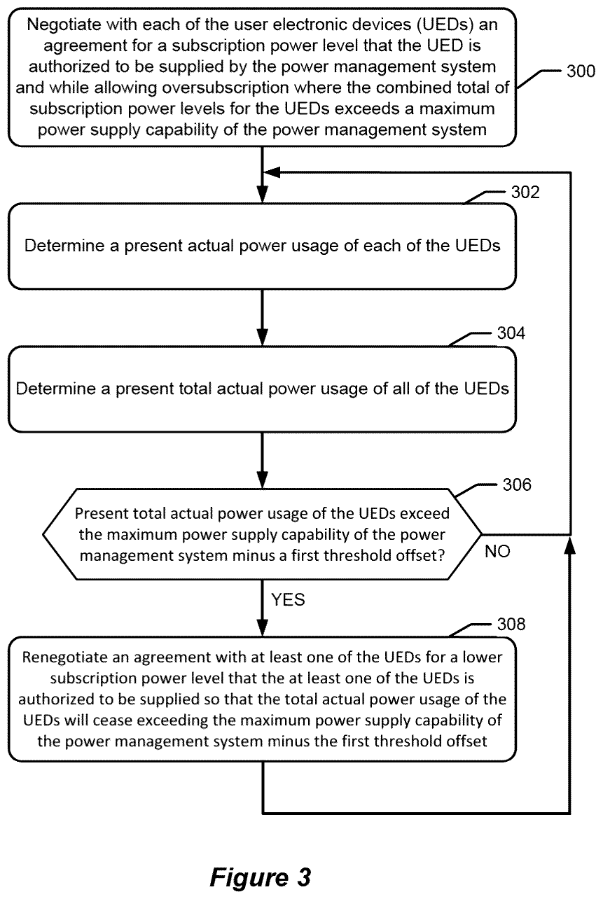

Operations performed by the power manager circuit 210 are now described with further reference to the flowchart of FIG. 3.

Referring to FIGS. 2 and 3, the power manager circuit 210 is configured, for each of the UEDs 240, to operate to negotiate 300 with the UED 240 an agreement for a subscription power level that the UED 240 is authorized to be supplied by the power management system 208. The power manager circuit 210 is configured to allow an oversubscription state by operations agreeing to subscription power levels for the UEDs 240 that when combined into a total subscription power level exceeds a maximum power supply capability of the power management system 208. The maximum power supply capability of the power management system 208 may correspond to a rated maximum power level that can be supplied by the power management system 208 and/or a maximum power level that is allowed to be supplied to the power management system 208 by the aircraft electrical power system 200. The power monitor and control circuit 220 is configured to control power level supplied to the connected UED 240 based on the subscription power level for the UED 240 and/or based on a command from the power manager circuit 210, e.g., a command to cease or adjust the supplied power level.

For each of the UEDs 240, the power manager circuit 210 determines 302 a present actual power usage of the UED 240 based on the measured power indication from one of the power monitor and control circuit 220 measuring actual power supplied through the power output 230 connected to one of the UEDs 240. The power manager circuit 210 determines 304 a present total actual power usage of the UEDs 240 based on a combination of the measured power indications from the power monitor and control circuits 220. Responsive to determining 306 that the present total actual power usage of the UEDs 240 exceeds the maximum power supply capability of the power management system 208 minus a first threshold offset, the power manager circuit 210 renegotiates 308 an agreement with at least one of the UEDs 240 for a lower subscription power level that the at least one of the UEDs 240 is authorized to be supplied so that the total actual power usage of the UEDs 240 will cease exceeding the maximum power supply capability of the power management system 208 minus the first threshold offset.

The first threshold offset can be defined based on a power level below the maximum power supply capability of the power management system 208, which when exceeded by the total actual power usage of the UEDs 240 triggers a remedial action by the power manager circuit 210 to perform the renegotiation of a lower subscription power level for at least one of the UEDs 240 to ensure the maximum power supply capability of the power management system 208 is not exceeded. The value of the first threshold offset can be defined to be sufficient so that the remedial action is triggered and the renegotiation is completed before the maximum power supply capability of the power management system 208 could be exceeded.

The power manager circuit 210 may compare the total actual power usage of the UEDs 240 to the maximum power supply capability of the power management system 208 minus a second threshold offset, where the second threshold offset is less than the first threshold offset. When the total actual power usage of the UEDs 240 exceeds the maximum power supply capability of the power management system 208 minus a second threshold offset, an immediate hard-stop is triggered to stop power supply through one or more of the power outputs 230, e.g., by the power manager circuit 210 commanding one or more of the power monitor and control circuits 220 to stop supplying power to connected UED(s) 240.

The power manager circuit 210 may set the first threshold offset value and any second threshold value based on one or more power management policies 212 that may be configured by the IFE controller 160, a configuration message received from a ground-based operations center, etc. The one or more power management policies 212 may define or influence what operations by the power manager circuit 210 are performed for the negotiations 300 and/or the renegotiations 308 in FIG. 3.

After completing renegotiation 308 of the agreement with the at least of the UEDs 240 for the lower subscription power level, the power manager circuit 210 may respond to a determination that a new present total actual power usage of the UEDs 240 no longer exceeds the maximum power supply capability of the power management system 208 minus the first threshold offset, by performing operations to further renegotiate agreement with the at least one of the UEDs 240 for a higher subscription power level that the at least one of the UEDs 240 is authorized to be supplied so that a total actual power usage of the UEDs 240 will increase without exceeding the maximum power supply capability of the power management system 208 minus the first threshold offset. In this manner, the power manager circuit 210 can negotiate a temporary lower subscription power level to a UED and later increase the subscription power level to that UED when the new present total actual power usage of the UEDs 240 is sufficiently below the maximum power supply capability of the power management system 208 minus the first threshold offset.

The negotiation 300 and renegotiation 308 operations can be performed using the USB Power Delivery (USB PD) protocol according to the USB-C standard to enable faster charging and increased power delivery capabilities of the power management system 208 to UEDs 240. Based on using the USB PD protocol, when a USB-C connection is in an attached state, USB PD negotiation occurs between the power manager circuit 210 (e.g., via operation of the power monitor and control circuit 220) and a UED 240, allowing for the negotiation of power delivery modes and values and agreement of a subscription power level to be supplied to the UED 240.

The negotiation 300 and/or renegotiation 308 may include negotiations/renegotiations with the UEDs 204 based on a fair share policy providing allocation of subscription power levels for the UEDs 240 based on at least one of: comparison of durations that the UEDs 240 have been supplied power under present subscription power levels; comparison of the present subscription power levels; and comparison of power levels originally requested by the UEDs 240. Thus, for example, a UED that has been charging longer duration may be provided a lower subscription power level than another UED that has been charging for a shorter duration.

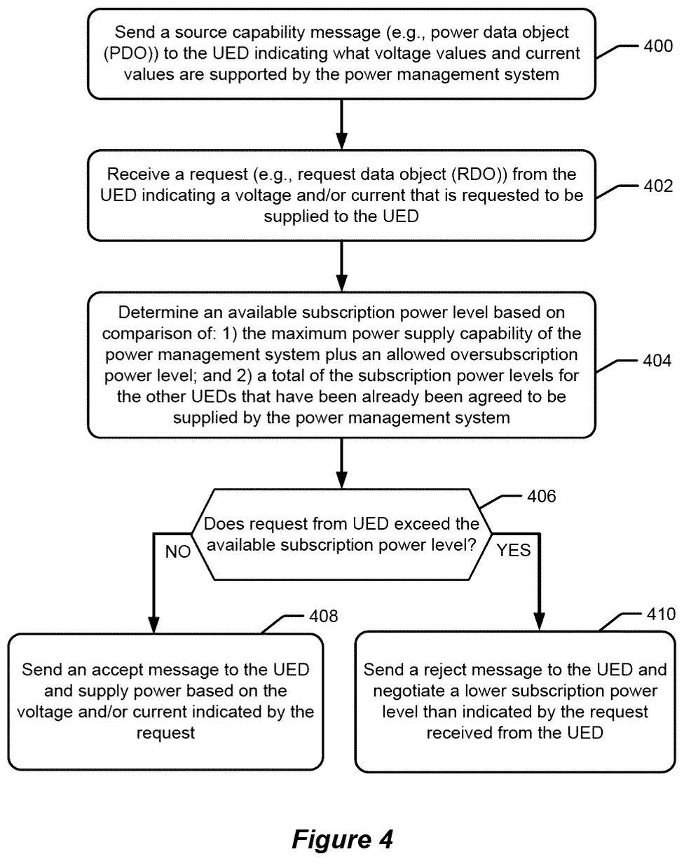

FIG. 4 illustrates a flowchart of optional operations by the power manager circuit to negotiate subscription power levels with the UEDs while allowing oversubscription of the combined total subscription power levels for the UEDs, in accordance with various embodiments of the present disclosure.

Referring to FIG. 4, when a USB-C connection is in an attached state, the power manager circuit 210 (e.g., via operation of the power monitor and control circuit 220) performs negotiation 300 of a subscription power level with the attached UED 240. The operations first identify the capabilities of the USB-C connection before sending 400 a source capabilities message to the UED 240 containing power data objects (PDOs). The PDOs indicate different voltage and current values, allowing for flexibility in charging different UED requirements. For example, a phone may only use up to 9 Volts at 3 Amps. In contrast, a laptop computer may use up to 20 Volts at 5 Amps. Supporting a variety of PDOs allows each UED 240 to pick one of the PDOs which satisfies its electrical power supply needs and compatibilities. Assuming the UED 240 is capable of USB PD, it can respond to the source capabilities message with a request data object (RDO) which is received 402 by the power manager circuit 210. The RDO indicates a PDO index (identifying one of the PDOs identified in the source capabilities message) and includes additional information about the requested voltage and/or current. The power manager circuit 210 then responds with an accept message 408 or reject message 410. If accepted, the power manager circuit 210 (e.g., via operation of the power monitor and control circuit 220) changes the supplied voltage and current before sending back a power supply ready message (PS Ready). The PS Ready establishes the subscription power level to be supplied to the UED 240 and signals that the UED 240 can begin drawing (consuming) the requested power level specified in the RDO.

The PDOs may be of three types: fixed, variable, or battery. Fixed PDOs are for a pre-defined fixed voltage with a maximum current value. For example, 5 v output of a legacy non-USB-C port can be handled by fixed PDOs along with 9 v, 12 v (deprecated), 15 v, and 20 v. Variable PDOs are for power supplies that swing in voltage between an advertised minimum and maximum with a maximum current value. Battery PDOs are for direct connections with a battery and specify minimum and maximum voltage with maximum power.

Augmented Power Data Objects (APDO) may be used as an extension of the original PDOs provided in USB PD. APDOs expose additional power delivery objects such as Standard Power Range Programmable Power Supply (SPR) and Extended Power Range Adjustable Voltage Supply (EPR). SPR covers a voltage range, e.g., from 3.3 to 21 volts, while EPR covers another voltage range, e.g., from 15 to 48 volts. These modes allow for fine control by the power manager circuit 210 (e.g., via operation of the power monitor and control circuit 220) over the power supplied (e.g., during UED charging), including setting different voltage and current values throughout charging. The power manager circuit 210 (e.g., via operation of the power monitor and control circuit 220) may operate to supply power in a constant current mode at the RDO current setpoint allowing for constant current supply to a UED 240.

As explained above in accordance with various present embodiments, when the power manager circuit 210 performs the negotiation 300 with an attached (e.g., UED 240 plugged into a USB-C charging outlet 232) for an agreement to a subscription power level that the UED 240 is authorized to be supplied by the power management system 208, the power manager circuit 210 is configured to allow an oversubscription state by operations agreeing to subscription power levels for the UEDs 240 that when combined into a total subscription power level exceeds a maximum power supply capability of the power management system 208.

The negotiation operations may include the power manager circuit 210 determining 404 an available subscription power level based on comparison of: 1) the maximum power supply capability of the power management system 208 plus an allowed oversubscription power level; and 2) a total of the subscription power levels for the other UEDs 240 that have already been agreed to be supplied by the power management system 208. The oversubscription power level is defined as a non-zero value so that a total of the subscription power levels allocated to all attached UEDs can exceed the maximum power supply capability of the power management system 208 by the amount of the oversubscription power level. The value of the oversubscription power level can be defined based on how quickly the power manager circuit 210 is able to identify and complete operations to remedy through renegotiation(s) when the condition occurs that the total actual power usage of the UEDs 240 exceeds the maximum power supply capability of the power management system 208 minus the first threshold offset (operations 306 and 308 in FIG. 3). The value of the oversubscription power level can therefore be defined to function as a safety margin that is sufficiently large so that normal operation of the power management system 308 is sufficiently responsive to the measurements and with remedial action to not allow the UEDs 240 to be supplied more total power than the power management system 208 is capable of supplying from the aircraft electrical power source 200.

In FIG. 4, operations determine 406 whether the request from the UED 240 exceeds the available subscription power level. When the request from the UED 240 does not exceed the available subscription power level, the power manager circuit 210 operates to send 408 an accept message to the UED 240 and supply power based on the voltage and/or current indicated by the request. In contrast, when the request from the UED 240 exceeds the available subscription power level, the power manager circuit 210 operates to send 410 a reject message to the UED and negotiate a lower subscription power level than indicated by the request received from the UED 240.

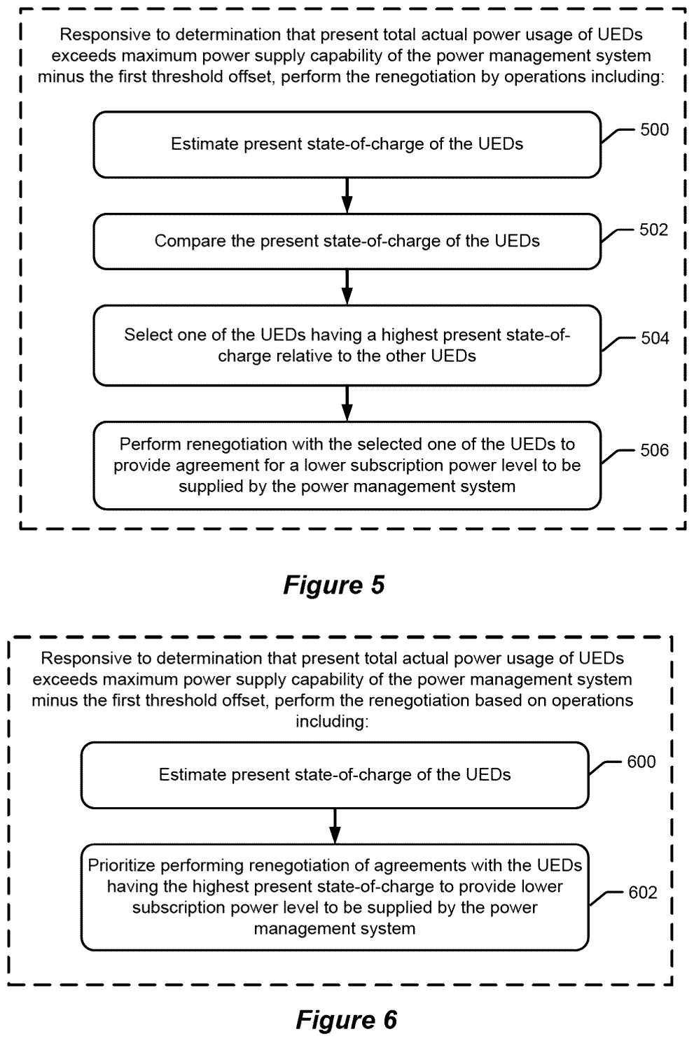

Additional operations that may be performed during the negotiation 300 and/or the renegotiation 308 are now discussed with reference to FIGS. 5-9, in accordance with some embodiments.

These operations can select the subscription power level allowed to be used by a UED 240 based on characteristics of the UED 240, such as the UED's 204 present battery state-of-charge (SoC), how quickly the battery of UED 240 can be charged from an insufficient SoC level (e.g., UED 240 has less than X % or minutes operational life) to a sufficient SoC to enable decreasing or ceasing charging of that UED 240 while power allocation is increased to another UED 240, etc.

These operations could address the scenario where a first passenger plugs into a charging outlet 232 a laptop that is above 90% charged but which requests a relatively high power allocation, and then a second passenger plugs in a laptop that is below 10% charged but, without new power allocation decisions during the negotiation process, would not be allocated sufficient power to charge and would therefore quickly become unusable to the second passenger. In accordance with some embodiments, the first passenger's laptop subscription power level can be lowered (e.g., by renegotiation) to enable the second passenger's laptop subscription level to be higher than would otherwise be allowable.

FIG. 5 illustrates a flowchart of optional operations by the power manager circuit 210 to select a UED 240 for renegotiation of lower subscription power level, in accordance with various embodiments of the present disclosure.

Referring to FIG. 5, the illustrated operations are performed by the power manager circuit 210 when responding to the determination that the present total actual power usage of the UEDs 240 exceeds the maximum power supply capability of the power management system 208 minus the first threshold offset. The operations renegotiate agreement with the at least one of the UEDs 240 for a lower subscription power level that the at least one of the UEDs is authorized to be supplied so that the total actual power usage of the UEDs will cease exceeding the maximum power supply capability of the power management system minus the first threshold offset.

As shown in FIG. 5, the operations include to estimate 500 present state-of-charge of the UEDs 204, and compare 502 the present state-of-charge of the UEDs 240. The operations then select 504 one of the UEDs 240 having a highest present state-of-charge relative to the other UEDs 240, and perform 506 renegotiation with the selected one of the UEDs 240 to provide agreement for a lower subscription power level to be supplied by the power management system 208.

A UED's state-of-charge may be estimated based on a data object received from the UED (e.g., the UED may report its state-of-charge or may be queried to provide an indication of the state-of-charge) or based on a profile of the power level measurements over time for the UED (e.g., a battery having a low state-of-charge (e.g., less than 30%) can draw more power than when the battery has a high state-of-charge (e.g., more than 70%) based on chemical characteristics and configuration of the battery).

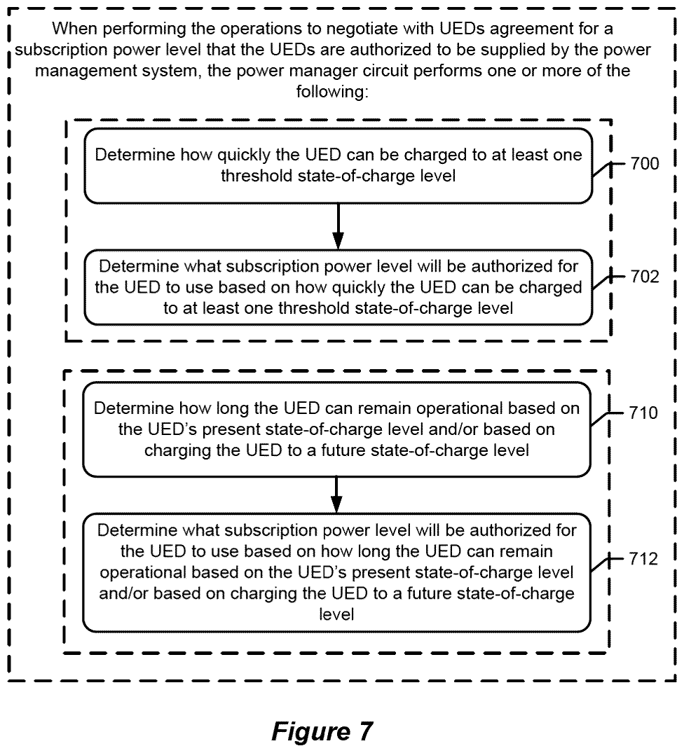

Optional alternative operations are illustrated in the flowchart of FIG. 6 which can be performed by the power manager circuit 210 to prioritize which UEDs 240 are prioritized for renegotiation of lower subscription power levels, in accordance with various embodiments of the present disclosure.

Referring to FIG. 6, the illustrated operations are again performed by the power manager circuit 210 when responding to the determination that the present total actual power usage of the UEDs 240 exceeds the maximum power supply capability of the power management system 208 minus the first threshold offset. The operations renegotiate agreement with the at least one of the UEDs 240 for a lower subscription power level that the at least one of the UEDs is authorized to be supplied so that the total actual power usage of the UEDs will cease exceeding the maximum power supply capability of the power management system minus the first threshold offset.

As shown in FIG. 6, the operations include to estimate 600 present state-of-charge of the UEDs 240, and to prioritize 602 performing renegotiation of agreements with the UEDs 240 having the highest present state-of-charge to provide lower subscription power level to be supplied by the power management system 208. In this manner, UEDs 240 which have higher battery state-of-charge would be renegotiated to receive lower subscription power levels before UEDs 240 and, if completion of those renegotiations sufficiently lowers the total actual power usage of the UEDs 240 then other UEDs 240 which has lower battery state-of-charge may not have their existing subscription power levels changed (lowered).

The operation to prioritize 602 in FIG. 6 may include to generate a list of the UEDs 240 ordered based on their relative present state-of-charge and with UEDs 240 having higher present state-of-charge ordered higher in the list than other UEDs 240 having lower present state-of-charge. The operation can then prioritize performing renegotiation of agreements, to provide lower subscription power level to be supplied by the power management system 208, with a plurality of the UEDs 240 that are selected among the list of UEDs 240 based on their relative higher position in the list.

Some further optional embodiments are directed to operations through which the power manager circuit 210 determines (considers) how quickly the UEDs 240 can be charged to at least one threshold state-of-charge level when performing the negotiations 300 (FIG. 3) with the UEDs 240 for agreements for subscription power levels.

The speed at which a UED 240 can be capable of charging may be determined based on a data object received from the UED (e.g., the UED may report its charging speed or may be queried to provide information indicative of the charging speed, such as the battery capacity, identity of the type of device, etc.) or based on a profile of the power level measurements over time for the UED.

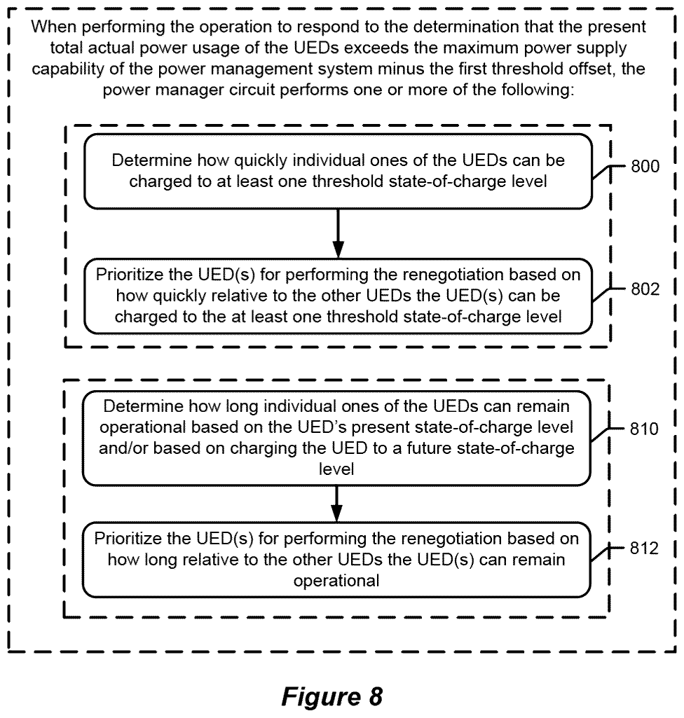

FIG. 7 illustrates a flowchart of optional operations by the power manager circuit 210, when performing the operations to negotiate with UEDs 240 agreement for a subscription power level that the UEDs 240 are authorized to be supplied, to consider how quickly the UED can be charged to at least one threshold state-of-charge level and/or to consider how long the UED 240 can remain operational based on the UED's 240 present state-of-charge level and/or based on charging the UED 240 to a future state-of-charge level (e.g., estimated based on its present or future state-of-charge and its power consumption rate), in accordance with various embodiments of the present disclosure.

Referring to FIG. 7, the operations may configure the power manager circuit 210 to determine 700 (consider) how quickly a UED 240 can be charged to at least one threshold state-of-charge level when performing the operation to negotiate with the UED 240 an agreement for a subscription power level that the UED 240 is authorized to be supplied by the power management system. The power manager circuit 210 determines 702 what subscription power level will be authorized for the UED 240 to use based on how quickly the UED 240 can be charged to at least one threshold state-of-charge level.

Also as shown in FIG. 7, the operations may optionally additionally include or operationally alternatively include configuring the power manager circuit 210 to determine 710 (consider) how long a UED 240 can remain operational based on the UED's 240 present state-of-charge level and/or based on charging the UED 240 to a future state-of-charge level when performing the operation to negotiate with the UED 240 an agreement for a subscription power level that the UED 240 is authorized to be supplied by the power management system 208. The power manager circuit 210 determines 712 what lower subscription power level will be authorized for the UED 240 to use based on how long the UED 240 can remain operational based on the UED's 240 present state-of-charge level and/or based on charging the UED to a future state-of-charge level.

Some further optional embodiments are directed to operations through which the power manager circuit 210 considers how quickly the UEDs 240 can be charged to at least one threshold state-of-charge level when performing the renegotiations 308 (FIG. 3) of agreement with at least one of the UEDs 240 for a lower subscription power level to be supplied.

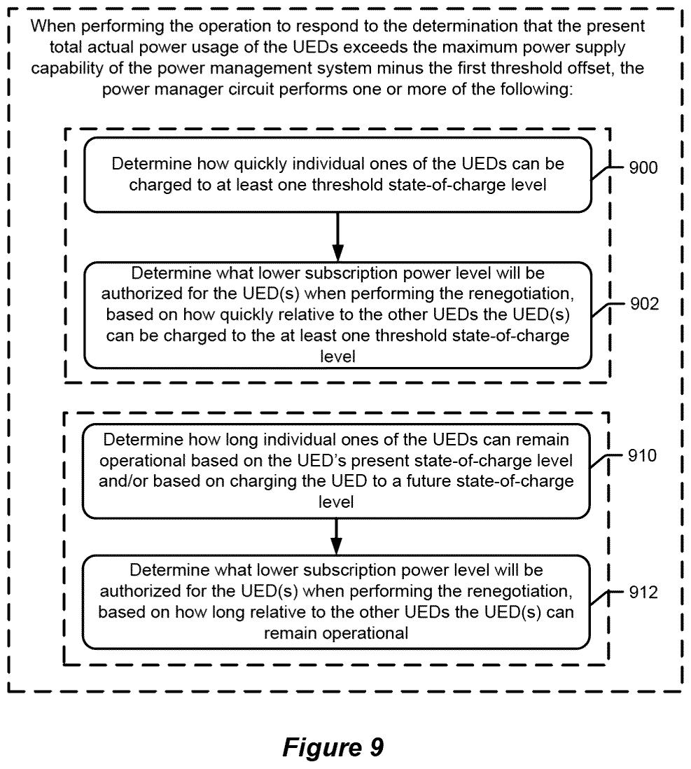

FIG. 8 illustrates a flowchart of optional operations by the power manager circuit 210 to respond to a determination that the present total actual power usage of the UEDs 240 exceeds the maximum power supply capability of the power management system 208 minus the first threshold offset by prioritizing which of the UEDs 240 to renegotiate with based on considering one or more of: how quickly the UEDs 240 can be charged to at least one threshold state-of-charge level; and/or how long a UED 240 can remain operational based on the UED's 240 present state-of-charge level and/or based on charging the UED 240 to a future state-of-charge level, in accordance with various embodiments of the present disclosure.

Referring to FIG. 8, the operations may configure the power manager circuit 210 to determine 800 (consider) how quickly individual ones of the UEDs 240 can be charged to at least one threshold state-of-charge level when performing the operation to respond to the determination 306 (FIG. 3) that the present total actual power usage of the UEDs 240 exceeds the maximum power supply capability of the power management system 308 minus the first threshold offset, by renegotiating 308 (FIG. 3) agreement with the at least one of the UEDs 240 for a lower subscription power level that the at least one of the UEDs 240 is authorized to be supplied so that the total actual power usage of the UEDs 240 will cease exceeding the maximum power supply capability of the power management system 308 minus the first threshold offset. The operations prioritize 802 at least one of the UEDs 240 for performing the renegotiation based on how quickly relative to the other UEDs 240 the at least one of the UEDs 240 can be charged to the at least one threshold state-of-charge level.

Also as shown in FIG. 8, the operations may optionally additionally include or operationally alternatively include configuring the power manager circuit 210 to determine 810 (consider) determine how long individual ones of the UEDs 240 can remain operational based on their respective present state-of-charge level and/or based on charging them to respective future state-of-charge level, when performing the operation to respond to the determination 306 (FIG. 3) that the present total actual power usage of the UEDs 240 exceeds the maximum power supply capability of the power management system 208 minus the first threshold offset, by renegotiating 308 (FIG. 3) agreement with the at least one of the UEDs 240 for a lower subscription power level that the at least one of the UEDs 240 is authorized to be supplied so that the total actual power usage of the UEDs 240 will cease exceeding the maximum power supply capability of the power management system minus the first threshold offset. The operations prioritize 812 the at least one of the UEDs 240 for performing the renegotiation based on how long relative to the other UEDs 240 the at least one of the UEDs 240 can remain operational.

Thus, for example, a UED having a relative long remaining operational life from its internal battery (e.g., estimated based on its state-of-charge and its power consumption rate) can be prioritized over another UED having a relatively relative short remaining operational life from its internal battery. The other UED having the relatively relative short remaining operational life may therefore not have its subscribed power level reduced if the renegotiations with more prioritized UED(s) is sufficient in reducing the total actual power usage.

Some further optional embodiments are directed to operations during the renegotiation operation 308 (FIG. 3) through which the power manager circuit 210 determines what lower subscription power level will be authorized for the at least one of the UEDs 240 based on how quickly relative to the other UEDs 240 the at least one of the UEDs 240 can be charged to the at least one threshold state-of-charge level and/or based on how long relative to the other UEDs 240 the at least one of the UEDs 240 can remain operational.

FIG. 9 illustrates a flowchart of optional operations by the power manager circuit 210 to respond to a determination that the present total actual power usage of the UEDs 240 exceeds the maximum power supply capability of the power management system 208 minus the first threshold offset by determining what lower subscription power level will be authorized to which of the UEDs 240 based on considering one or more of: how quickly the UEDs 240 can be charged to at least one threshold state-of-charge level; and/or how long a UED 240 can remain operational based on the UED's 240 present state-of-charge level and/or based on charging the UED 240 to a future state-of-charge level, in accordance with various embodiments of the present disclosure.

Referring to FIG. 9, the operations configure the power manager circuit 240 to determine 900 how quickly individual ones of the UEDs 240 can be charged to at least one threshold state-of-charge level. The operations further configure the power manager circuit 240 to determine 902 what lower subscription power level will be authorized for the at least one of the UEDs based on how quickly relative to the other UEDs the at least one of the UEDs can be charged to the at least one threshold state-of-charge level.

Thus, for example, a UED capable of more quickly charging to a threshold state-of-charge (e.g., charge to X% SoC) can have its subscription power level left unchanged or reduced a smaller amount than another UED that is capable of only a slower charging speed to the threshold state-of-charge (e.g., charge to X % SoC). The quicker charging UED may thereby be quickly charged to the threshold SoC and may then be stopped charging or reduced to a lower level to allow charging to start or to be increased for the slower charging other UED.

Also as shown in FIG. 9, the operations may optionally additionally include or operationally alternatively include configuring the power manager circuit 210 to determine 910 (consider) how long individual ones of the UEDs 240 can remain operational based on their respective present state-of-charge level and/or based on charging them to respective future state-of-charge level. The operations further configure the power manager circuit 240 to determine 912 what lower subscription power level will be authorized for the UED 240 to use based on how long relative to the other UEDs 240 the at least one of the UEDs 240 can remain operational.

Thus, for example, a UED that is capable of remaining operational for a longer time from its internal battery relative to another UED, can have its subscription power level changed to proportionally lower level or have its power supply stopped entirely compared to the other UED which has a shorter operational time.

Some other embodiments are directed to operations that configure the power manager circuit 210 to cycle between UEDs 240 to temporarily provide to a UED 240 the requested subscription power level during a first duration and then provide a lower subscription power level to the UED 240 during a second duration. The first duration and the second duration are determined based on at least one of: present state-of-charge level; how quickly the UED 240 can be charged to a threshold state-of-charge level; and how long the UED 240 can remain operational based on the present state-of-charge level and/or based on charging the UED 240 to a future state-of-charge level. For example, the operations may charge a UED 240 to a threshold level during a first duration and then cease charging that UED 240 for a second duration that is less that the UED's 240 estimated operational time remaining from the threshold level state-of-charge, and then restart charging before the UED 240 runs out of operational power.

In accordance with one corresponding embodiment, the power manager circuit 240 is configured to cycle between the UEDs 240 to perform renegotiations of agreements that temporarily provides to the UED 240 during a first duration a subscription power level that is requested by the UED 240 and to then provide to the UED 240 a lower subscription power level during a second duration. The first duration and the second duration are operationally determined based on at least one of: present state-of-charge level of the UED 240; how quickly the UED 240 can be charged to a threshold state-of-charge level; and how long the UED 240 can remain operational based on the present state-of-charge level and/or based on charging the UED 240 to a future state-of-charge level.

Potential advantages that may be provide by one or more of the embodiments disclosed herein can include one or more of the following:

Cost Savings: By avoiding the need to size the infrastructure for the absolute peak demand, which may occur infrequently, oversubscription reduces the upfront capital expenditure required for the charging infrastructure.

Space Optimization: A smaller infrastructure footprint translates to more efficient use of available space, making it easier to deploy charging solutions in space-constrained environments.

Scalability: As the demand for charging increases, oversubscription allows for gradual expansion of the infrastructure capacity, rather than requiring a complete overhaul to accommodate the worst-case scenario from the outset.

Energy Efficiency: By dynamically allocating power based on actual demand, oversubscription minimizes energy waste and promotes more efficient use of available resources.

With fair sharing: The operation can support fair sharing of available power based on actual power consumption, rather than restricted to, e.g., a first-come, first-served approach preventing underutilization of resources.

### Further Definitions and Embodiments

In the above description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity.

The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the following examples of embodiments and their equivalents, and shall not be restricted or limited by the foregoing detailed description.

1. A power management system comprising:
a plurality of power monitor and control circuits connected to power outputs configured to supply power to user electronic devices (UEDs), each of the power monitor and control circuits configured to measure actual power supplied through one of the power outputs to one of the connected UEDs and to responsively generate a measured power indication; and
a power manager circuit configured to perform operations to,
for each of the UEDs, negotiate with the UED an agreement for a subscription power level that the UED is authorized to be supplied by the power management system, wherein the power manager circuit is configured to allow an oversubscription state by operations agreeing to subscription power levels for the UEDs that when combined into a total subscription power level exceeds a maximum power supply capability of the power management system, wherein the power monitor and control circuit is configured to control power level supplied to the connected UED based on the subscription power level for the UED and/or based on a command from the power manager circuit,
for each of the UEDs, determine a present actual power usage of the UED based on the measured power indication from the power monitor and control circuit measuring actual power supplied through the power output connected to the UED,
determine a present total actual power usage of the UEDs based on a combination of the measured power indications from the power monitor and control circuits, and
responsive to determining the present total actual power usage of the UEDs exceeds the maximum power supply capability of the power management system minus a first threshold offset, renegotiate an agreement with at least one of the UEDs for a lower subscription power level that the at least one of the UEDs is authorized to be supplied so that the total actual power usage of the UEDs will cease exceeding the maximum power supply capability of the power management system minus the first threshold offset.

2. The power management system of claim 1, wherein the power manager circuit is further configured to operate to perform the negotiations with the UEDs based on a fair share policy providing allocation of subscription power levels for the UEDs based on at least one of: comparison of durations that the UEDs have been supplied power under present subscription power levels; comparison of the present subscription power levels; and comparison of power levels originally requested by the UEDs.

3. The power management system of claim 1, wherein the power manager circuit is further configured to operate to negotiate with the UED an agreement for an oversubscription power level that the UED is authorized to be supplied by the power management system and which will create the oversubscription state, by operations to:
send a source capability message to the UED indicating what voltage values and current values are supported by the power management system;
receive a request from the UED indicating a voltage and/or current that is requested to be supplied to the UED;
determine an available subscription power level based on comparison of: 1) the maximum power supply capability of the power management system plus an allowed oversubscription power level; and 2) a total of the subscription power levels for the other UEDs that have already been agreed to be supplied by the power management system;
when the request from the UED does not exceed the available subscription power level, send an accept message to the UED and supply power based on the voltage and/or current indicated by the request; and
when the request from the UED exceeds the available subscription power level, send a reject message to the UED and negotiate a lower subscription power level than indicated by the request received from the UED.

4. The power management system of claim 3, wherein:
the source capability message sent by the power manager circuit comprises a power data object (PDO); and
the request received from the UED comprises a request data object (RDO).

5. The power management system of claim 1, wherein the power manager circuit is further configured to perform operations to:
after completing renegotiation of the agreement with the at least of the UEDs for the lower subscription power level, respond to determining that a new present total actual power usage of the UEDs no longer exceeds the maximum power supply capability of the power management system minus the first threshold offset by performing operations to further renegotiate agreement with the at least one of the UEDs for a higher subscription power level that the at least one of the UEDs is authorized to be supplied so that a total actual power usage of the UEDs will increase without exceeding the maximum power supply capability of the power management system minus the first threshold offset.

6. The power management system of claim 5, wherein the operations to negotiate, to renegotiate, and to further renegotiate are performed by the power manager circuit using USB PD protocol communications with the UEDs.

7. The power management system of claim 1, wherein the operation by the power manager circuit to respond to the determination that the present total actual power usage of the UEDs exceeds the maximum power supply capability of the power management system minus the first threshold offset, by renegotiation agreement with the at least one of the UEDs for a lower subscription power level that the at least one of the UEDs is authorized to be supplied so that the total actual power usage of the UEDs will cease exceeding the maximum power supply capability of the power management system minus the first threshold offset, comprises operations to:
estimate present state-of-charge of the UEDs;
compare the present state-of-charge of the UEDs;
select one of the UEDs having a highest present state-of-charge relative to the other UEDs; and
perform renegotiation with the selected one of the UEDs to provide agreement for a lower subscription power level to be supplied by the power management system.

8. The power management system of claim 1, wherein the operation by the power manager circuit to respond to the determination that the present total actual power usage of the UEDs exceeds the maximum power supply capability of the power management system minus the first threshold offset, by renegotiation agreement with the at least one of the UEDs for a lower subscription power level that the at least one of the UEDs is authorized to be supplied so that the total actual power usage of the UEDs will cease exceeding the exceeding the maximum power supply capability of the power management system minus the first threshold offset, comprises operations to:
estimate present state-of-charge of the UEDs;
prioritize performing renegotiation of agreements with the UEDs having the highest present state-of-charge to provide lower subscription power level to be supplied by the power management system.

9. The power management system of claim 8, wherein the operation by the power manager circuit to prioritize performing renegotiation of agreements with the UEDs having the highest present state-of-charge to provide lower subscription power level to be supplied by the power management system, further comprises operations to:
generate a list of the UEDs ordered based on their relative present state-of-charge and with UEDs having higher present state-of-charge ordered higher in the list than other UEDs having lower present state-of-charge;
prioritize performing renegotiation of agreements, to provide lower subscription power level to be supplied by the power management system, with a plurality of the UEDs that are selected among the list of UEDs based on their relative higher position in the list.

10. The power management system of claim 1, wherein:
the power manager circuit is configured to determine how quickly a UED can be charged to at least one threshold state-of-charge level when performing the operation to negotiate with the UED an agreement for a subscription power level that the UED is authorized to be supplied by the power management system, wherein the power manager circuit determines what subscription power level will be authorized for the UED to use based on how quickly the UED can be charged to at least one threshold state-of-charge level.

11. The power management system of claim 1, wherein:
the power manager circuit is configured to determine how quickly individual ones of the UEDs can be charged to at least one threshold state-of-charge level when performing the operation to respond to the determination that the present total actual power usage of the UEDs exceeds the maximum power supply capability of the power management system minus the first threshold offset, by renegotiating agreement with the at least one of the UEDs for a lower subscription power level that the at least one of the UEDs is authorized to be supplied so that the total actual power usage of the UEDs will cease exceeding the maximum power supply capability of the power management system minus the first threshold offset, wherein the at least one of the UEDs is prioritized for performing the renegotiation based on how quickly relative to the other UEDs the at least one of the UEDs can be charged to the at least one threshold state-of-charge level.

12. The power management system of claim 1, wherein:
the power manager circuit is configured to determine how quickly individual ones of the UEDs can be charged to at least one threshold state-of-charge level when performing the operation to respond to the determination that the present total actual power usage of the UEDs exceeds the maximum power supply capability of the power management system minus the first threshold offset, by renegotiating agreement with the at least one of the UEDs for a lower subscription power level that the at least one of the UEDs is authorized to be supplied so that the total actual power usage of the UEDs will cease exceeding the maximum power supply capability of the power management system minus the first threshold offset, wherein the power manager circuit determines what lower subscription power level will be authorized for the at least one of the UEDs based on how quickly relative to the other UEDs the at least one of the UEDs can be charged to the at least one threshold state-of-charge level.

13. The power management system of claim 1, wherein:
the power manager circuit is configured to consider how long a UED can remain operational based on the UED's present state-of-charge level and/or based on charging the UED to a future state-of-charge level when performing the operation to negotiate with the UED an agreement for a subscription power level that the UED is authorized to be supplied by the power management system, wherein the power manager circuit determines what lower subscription power level will be authorized for the UED to use based on how long the UED can remain operational based on the UED's present state-of-charge level and/or based on charging the UED to a future state-of-charge level.

14. The power management system of claim 1, wherein:
the power manager circuit is configured to determine how long individual ones of the UEDs can remain operational based on their respective present state-of-charge level and/or based on charging them to respective future state-of-charge level, when performing the operation to respond to the determination that the present total actual power usage of the UEDs exceeds the maximum power supply capability of the power management system minus the first threshold offset, by renegotiating agreement with the at least one of the UEDs for a lower subscription power level that the at least one of the UEDs is authorized to be supplied so that the total actual power usage of the UEDs will cease exceeding the maximum power supply capability of the power management system minus the first threshold offset, wherein the at least one of the UEDs is prioritized for performing the renegotiation based on how long relative to the other UEDs the at least one of the UEDs can remain operational.

15. The power management system of claim 1, wherein:
the power manager circuit is configured to determine how long individual ones of the UEDs can remain operational based on their respective present state-of-charge level and/or based on charging them to respective future state-of-charge level, when performing the operation to respond to the determination that the present total actual power usage of the UEDs exceeds the maximum power supply capability of the power management system minus the first threshold offset, by renegotiating agreement with the at least one of the UEDs for a lower subscription power level that the at least one of the UEDs is authorized to be supplied so that the total actual power usage of the UEDs will cease exceeding the maximum power supply capability of the power management system minus the first threshold offset, wherein the power manager circuit determines what lower subscription power level will be authorized for the UED to use based on how long relative to the other UEDs the at least one of the UEDs can remain operational.

16. The power management system of claim 1, wherein:
the power manager circuit is configured to cycle between the UEDs to perform renegotiations of agreements that temporarily provides to the UED during a first duration a subscription power level that is requested by the UED and to then provide to the UED a lower subscription power level during a second duration, wherein the first duration and the second duration are determined based on at least one of: present state-of-charge level of the UED; how quickly the UED can be charged to a threshold state-of-charge level; and how long the UED can remain operational based on the present state-of-charge level and/or based on charging the UED to a future state-of-charge level.

17. A method by a power management system including a plurality of power monitor and control circuits connected to power outputs configured to supply power to user electronic devices (UEDs), where each of the power monitor and control circuits are configured to measure actual power supplied through one of the power outputs to one of the connected UEDs and to responsively generate a measured power indication, the method comprising:
for each of the UEDs, negotiating with the UED an agreement for a subscription power level that the UED is authorized to be supplied by the power management system, wherein the negotiations allow an oversubscription state by agreeing to subscription power levels for the UEDs that when combined into a total subscription power level exceeds a maximum power supply capability of the power management system, wherein method controls power level supplied to the connected UED based on the subscription power level for the UED and/or based on a command from the power manager circuit,
for each of the UEDs, determining a present actual power usage of the UED based on the measured power indication from the power monitor and control circuit measuring actual power supplied through the power output connected to the UED,
determining a present total actual power usage of the UEDs based on a combination of the measured power indications from the power monitor and control circuits, and
responsive to determining the present total actual power usage of the UEDs exceeds the maximum power supply capability of the power management system minus a first threshold offset, renegotiating an agreement with at least one of the UEDs for a lower subscription power level that the at least one of the UEDs is authorized to be supplied so that the total actual power usage of the UEDs will cease exceeding the maximum power supply capability of the power management system minus the first threshold offset.

18. A computer program product comprising a non-transitory computer readable medium storing instructions executable by at least one processor of a power management system including a plurality of power monitor and control circuits connected to power outputs configured to supply power to user electronic devices (UEDs), where each of the power monitor and control circuits are configured to measure actual power supplied through one of the power outputs to one of the connected UEDs and to responsively generate a measured power indication, the instructions when executed by the at least one processor perform operations comprising to:
for each of the UEDs, negotiate with the UED an agreement for a subscription power level that the UED is authorized to be supplied by the power management system, wherein the negotiations allow an oversubscription state by agreeing to subscription power levels for the UEDs that when combined into a total subscription power level exceeds a maximum power supply capability of the power management system, wherein operations control power level supplied to the connected UED based on the subscription power level for the UED and/or based on a command from the power manager circuit,
for each of the UEDs, determine a present actual power usage of the UED based on the measured power indication from the power monitor and control circuit measuring actual power supplied through the power output connected to the UED,
determine a present total actual power usage of the UEDs based on a combination of the measured power indications from the power monitor and control circuits, and responsive to determining the present total actual power usage of the UEDs exceeds the maximum power supply capability of the power management system minus a first threshold offset, renegotiate an agreement with at least one of the UEDs for a lower subscription power level that the at least one of the UEDs is authorized to be supplied so that the total actual power usage of the UEDs will cease exceeding the maximum power supply capability of the power management system minus the first threshold offset.
